(19) United States
(12) Patent Application Publication
(10) Pub. No.: US 2012/0250053 A1
(43) Pub. Date: Oct. 4, 2012

(54) METHOD AND SYSTEM FOR HANDLING SUB-JOBS

(75) Inventors: Toshiyuki MITSUBORI, San Mateo, CA (US); Randy Cruz Soriano, San Leandro, CA (US)

(73) Assignee: KONICA MINOLTA LABORATORY U.S.A., INC., San Mateo, CA (US)

(21) Appl. No.: 13/076,616

(22) Filed: Mar. 31, 2011

(51) Int. Cl. G06F 3/12

(52) U.S. Cl. 358/1.13; 358/1.15

(57) ABSTRACT

A method of managing a plurality of print jobs executed by an image forming apparatus, which includes: processing a plurality of sub-print jobs that constitute a print job for printing by the image forming apparatus; assigning the plurality of sub-print jobs to a print job management module; managing the processing of each of the sub-print jobs with the print job management module, wherein the print job management module determines based on an estimated time for processing of each of the sub-print jobs, if the print job should be printed first sheet to last sheet with each of the sheets face down or last sheet to first sheet with each of the sheets face up; sending the processed sub-print jobs to a print queue for printing in an order according to the determination result by the print job management module; and printing the plurality of sub-print jobs in the print queue.

### FIELD OF THE INVENTION

The present invention relates to a system and method of managing plural print jobs, and more particularly, a system and method of managing a group or plurality of print jobs including sub-jobs, wherein the sub-jobs are printed top-to-bottom, or alternatively, bottom-to-top, which is achieved by monitoring the processing (or RIP) status for each of the sub-jobs using a print job management module.

### BACKGROUND OF THE INVENTION

In today's print on demand, it is common to generate a print job, which may contain many pages of text and images of various complexities. These complex jobs may heavily require and occupy long processing time (i.e., raster image processing or “RIP” time) on the printing device. In sequences of print jobs, this can become a bottleneck for other job waiting to be processed or RIPped as the printing device has to complete ripping of the current complex job before it can proceed to the subsequent print job.

It would be desirable to improve the management or processing of print jobs having sub-jobs (or sub-print jobs), by implementing a process wherein the sub-jobs are printed top-to-bottom, or alternatively, bottom-to-top, which provides for improved printer performance.

### SUMMARY OF THE INVENTION

In consideration of the above issues, it would be desirable to improve the management or processing of print jobs having sub-jobs (or sub-print jobs), wherein the sub jobs are printed top-to-bottom, or alternatively, bottom-to-top, which is achieved by monitoring the processing (or RIP) status for each of the sub jobs using a print job management module.

In accordance with an exemplary embodiment, a method of managing a plurality of print jobs executed by an image forming apparatus, the method comprises: processing a plurality of sub-print jobs that constitute a print job for printing by the image forming apparatus; assigning the plurality of sub-print jobs to a print job management module; managing the processing of each of the sub-print jobs with the print job management module, wherein the print job management module determines based on an estimated time for processing of each of the sub-print jobs, if the print job should be printed first sheet to last sheet with each of the sheets face down or last sheet to first sheet with each of the sheets face up; sending the processed sub-print jobs to a print queue for printing in an order according to the determination result by the print job management module; and printing the plurality of sub-print jobs in the print queue.

In accordance with a further exemplary embodiment, an image forming apparatus having executable instructions for managing a plurality of print jobs, the instructions comprising: processing a plurality of sub-print jobs that constitute a print job for printing by the image forming apparatus; assigning the plurality of sub-print jobs to a print job management module; managing the processing of each of the sub-print jobs with the print job management module, wherein the print job management module determines based on an estimated time for processing of each of the sub-print jobs, if the print job should be printed first sheet to last sheet with each of the sheets face down or last sheet to first sheet with each of the sheets face up; sending the processed sub-print jobs to a print queue for printing in an order according to the determination result by the print job management module; and printing the plurality of sub-print jobs in the print queue.

In accordance with another exemplary embodiment, a computer program product comprising a non-transitory computer usable medium having a computer readable code embodied therein for managing a plurality of print jobs on an image forming apparatus, the computer readable program code configured to execute a process, the process comprising the steps of: processing a plurality of sub-print jobs that constitute a print job for printing by the image forming apparatus; assigning the plurality of sub-print jobs to a print job management module; managing the processing of each of the sub-print jobs with the print job management module, wherein the print job management module determines based on an estimated time for processing of each of the sub-print jobs, if the print job should be printed first sheet to last sheet with each of the sheets face down or last sheet to first sheet with each of the sheets face up; sending the processed sub-print jobs to a print queue for printing in an order according to the determination result by the print job management module; and printing the plurality of sub-print jobs in the print queue

It is to be understood that both the foregoing general description and the following detailed description are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is an illustration of a data processing system, which includes a client device in the form of a computer device and an image forming apparatus or printer.

FIG. 1B is an illustration of a data processing system, which includes a plurality of client devices, and an image forming apparatus or printer.

FIG. 2 is an illustration of an image forming apparatus in accordance with an exemplary embodiment.

FIG. 3 is an illustration of a data processing system, which includes a plurality of client devices and an image forming apparatus in accordance with an exemplary embodiment.

FIG. 4 is an illustration of a print job management module in accordance with an exemplary embodiment.

FIG. 5 is an illustration of a checking mechanism of the print job controller module as shown in FIG. 4 in accordance with an embodiment.

FIG. 6 is an illustration of a flowchart, which describes the process in the group job checking module and the RIP completion time prediction module in accordance with an exemplary embodiment.

FIG. 7 is an illustration of a flowchart, which described the process in the RIP module in accordance with an exemplary embodiment.

FIG. 8 is an illustration of a flowchart, which describes the process in the RIP status updating module in accordance of an exemplary embodiment.

FIG. 9 is an illustration of a flowchart, which describes the process in the print job controller in accordance with an exemplary embodiment.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

In accordance with an exemplary embodiment, it can be appreciated that one method to manage a very complex job is to divide a print job into multiple sub-jobs, thereby, allowing faster ripping. These sub-jobs can then be stored in the printing device storage such as hard disk and by using a print job management module to manage these sub jobs to improve printer performance. In accordance with an exemplary embodiment, the print job management module can allocate a group of modules that serves as a collection for the ripped sub jobs until the whole of the print job has received. When the whole of the print job has been received and is ready to print, the print job management module releases the print job for printing. It can be appreciated that with this method, subsequent print jobs with lesser complexities can be ripped or processed with much less wait time.

Typically, in order for the whole of the print job to be released for printing, the print job has to wait until all of the sub-jobs have been received by the print engine. In case of processing (ripping) the sub jobs in parallel, processing of less complex sub jobs will be finished faster than the processing of more complex sub-jobs regardless of the desired print order, which may induce disordering of the sub-jobs. Accordingly, it would be desirable to have a method to manage the group of the sub jobs so that the print job, which comprised the sub-jobs can start printing top-to-bottom of the job (first page first) or bottom-to-top of the job (last page first) before each of the sub-jobs has been processed for improved printer performance. Accordingly, it can be appreciated that by using this system and method, printing can begin without waiting for RIP completion (or processing) of the entire or whole print job.

In accordance with an exemplary embodiment, a system and method of managing a group or plurality of print jobs including sub-jobs (or sub-print jobs), wherein the sub jobs are printed top-to-bottom, or alternatively, bottom-to-top, which is achieved by monitoring the processing (or RIP) status for each of the sub jobs using a print job management module.

For example, in accordance with an exemplary embodiment, a print job is divided into different sub jobs (1-1, 1-2, 1-3, 1-4, 1-5, 1-6 sequence) that requires printing order in the same sequence, such that when each of the sub-jobs has been processed (RIPped), the print job is ready to print. However, printing cannot just start without determining the proper order of the print job. Therefore, in accordance with an exemplary embodiment, the print job can be sorted either as start from top-to-bottom of the job (1-1, 1-2, 1-3, 1-4, 1-5, 1-6) or start from bottom-to-top of the job (1-6, 1-5, 1-4, 1-3, 1-2, 1-1). In accordance with an exemplary embodiment, if there are more sub-jobs that are available and ready for printing starting from the top-to-bottom approach (i.e., first sheet to last sheet with each of the sheets face down), then the printing begins with the top-to-bottom approach. In the top-to-bottom approach, the first page of the print job will be printed first and face down in order to produce the proper sorting of pages. Alternatively, if the print job management module determines that there are more sub-jobs available and ready for printing starting from the bottom-to-top approach (i.e., last sheet to first sheet with each of the sheets face up), then the printing begins starting with the last page of the print job and face up in order to produce proper sorting of pages. In either case, the determination can be made based on the number of such sub-jobs, the number of pages belonging to such sub-jobs, or the estimated print time to print these pages.

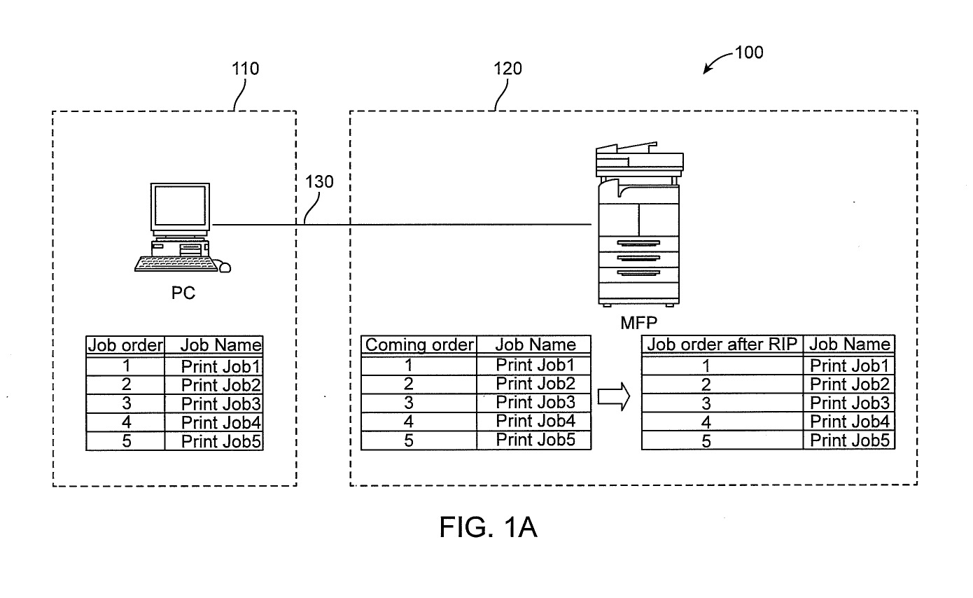

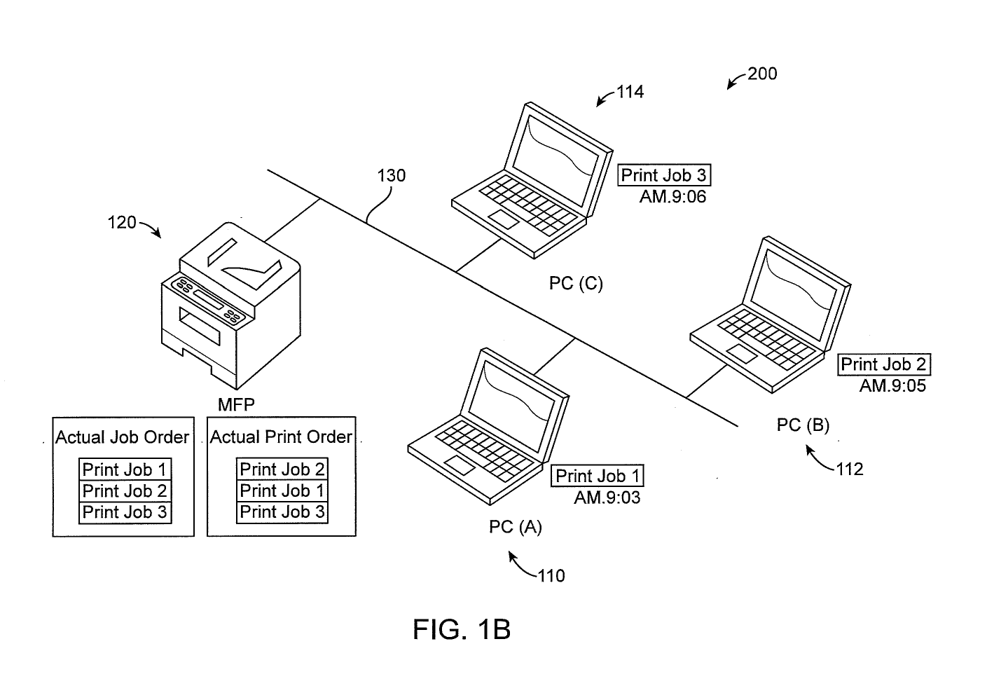

FIG. 1A is an illustration of a typical data processing system 100, which includes a client device (or computer device) 110 and an image forming apparatus 120 (or printer) connected to the client device 110. The client device 110 preferably includes a processor or central processing unit (CPU), one or more memories for storing software programs and data (such as files to be printed). The client device 110 also includes an operating system (OS), which manages the computer hardware and provides common services for efficient execution of various software programs. The processor or CPU carries out the instructions of a computer program, which operates and/or controls at least a portion of the functionality of the client device 110. It can be appreciated that examples of client devices 110 include and are not limited to personal computers, image forming apparatuses, routers, and/or personal digital assistants (PDAs).

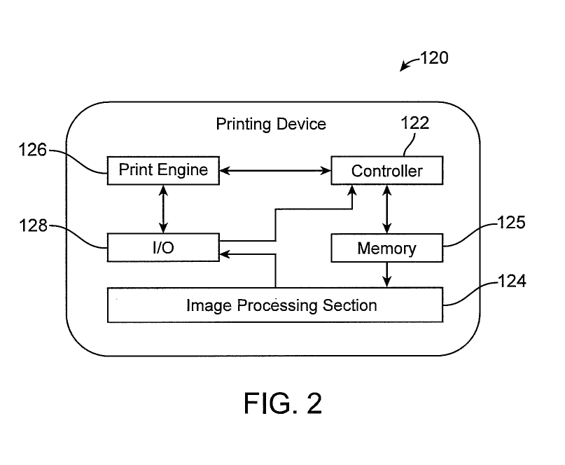

In accordance with an exemplary embodiment, the image forming apparatus is preferably in the form of an industrial image forming apparatus or multi-functional printer 120 connected to the client device 110. The client device 110 submits print jobs to the image forming apparatus (printer or printing device) 120 by transmitting data representing the documents to be printed and information describing the print job. As shown in FIG. 2, the image forming apparatus (i.e., printer/printing device) 120 typically includes a printer controller (or firmware) 122, an image processing section (or data dispatcher) 124, a memory section 125 preferably in the form of a hard disk drive (HDD), a print engine 126, and an input/output (I/O) section 128.

The controller 122 typically includes a central processing unit (CPU), a random access memory (RAM), and a read only memory (ROM). The central processing unit is configured to execute a sequence of stored instructions (i.e., a computer program). It can be appreciated that the controller 122 also includes an operating system (OS), which acts as an intermediary between the software programs and hardware components within the image forming apparatus 120. The operating system (OS) manages the computer hardware and provides common services for efficient execution of various application software. In accordance with an exemplary embodiment, the controller 122 processes the data and job information received from the client device 110 to generate a print image.

The image processing section 124 carries out image processing under the control of the controller 122, and sends the processed print image data to the print engine 126. In one embodiment, the image processing section 124 is preferably capable of processing multiple print jobs or sub jobs in parallel and independently. For instance, the image processing section 124 can include a CPU that contains multiple cores therein to realize the multiple RIP modules explained in detail later. The CPU used constituting a part of the controller can be commonly used for the image processing section. The print engine 126 forms an image on a recording sheet based on the image data sent from the image processing section. The I/O section 128 performs data transfer with the host computer 110. The controller 122 is programmed to process data and control various other components of the image forming apparatus or printer to carry out the various methods described herein. The hard disk drive (HDD) or storage device stores digital data and/or software programs for recall by the controller. In accordance with an exemplary embodiment, the digital data includes resources, which can include graphics/images, logos, form overlays, fonts, etc.

The input/output (I/O) port 128 provides communications between the printer section and the client device 110 and receives page descriptions (or print data) from the host for processing within the image forming apparatus 120. In accordance with an exemplary embodiment, the operation of printer section commences when it receives a page description from the client device 110 via I/O port in the form of a print job data stream. The page description may be any kind of page description languages (PDLs), such as PostScript® (PS), Printer Control Language (PCL), Portable Document Format (PDF), XML Paper Specification (XPS), and so on. Examples of image forming apparatuses 120 consistent with exemplary embodiments of the invention include industrial printers, and/or multi-function printers or peripherals (MFP).

The client device 110 and the image forming apparatus (or printer) 120 are preferably connected to one another via a network 130. Examples of the network 130 consistent with embodiments of the invention include, but are not limited to, the Internet, an intranet, a local area network (LAN) and a wide area network (WAN). The client device 110 and the image forming apparatus 120 can also be connected with a wire and/or wireless technology by using radio frequency (RF) and/or infrared (IR) transmission.

As shown in FIG. 1A, in accordance with an exemplary embodiment, the client device (or host computer) 110 sends a plurality or series of print jobs to a printing device or image forming apparatus 120. The plurality or series of print jobs are transmitted or sent by the client device 110 and received by the printing device 120, which may come in the same order. However, depending on complexities of each of the print jobs, less complex print jobs can be processed (or RIPped) faster than other print jobs and become available for printing before the more complex print jobs. Therefore, in some circumstances, the printing of the print job (or print job orders) can change after the RIP process.

FIG. 1B is an illustration of a data processing system 200, which includes a plurality of client devices 110, 112, 114 and an image forming apparatus or printing device 120. As shown in FIG. 1B, the data processing system consists of multiple client devices (or PCs) 110, 112, 114 that send sequence of print jobs to a printing device 120. Each of the plurality of client devices 110, 112, 114 and the printing device 120 is preferably connected to one another via a network connection 130. It can be appreciated that the as shown, the sequence of print jobs transmitted or sent by the client devices and received by the printing device may come in the same order. However, once again, depending on complexities of each of the print jobs, less complex print jobs can be processed (i.e., RIPped) faster and becomes available for printing before the more complex print jobs. Therefore, the job orders can change after the RIP process.

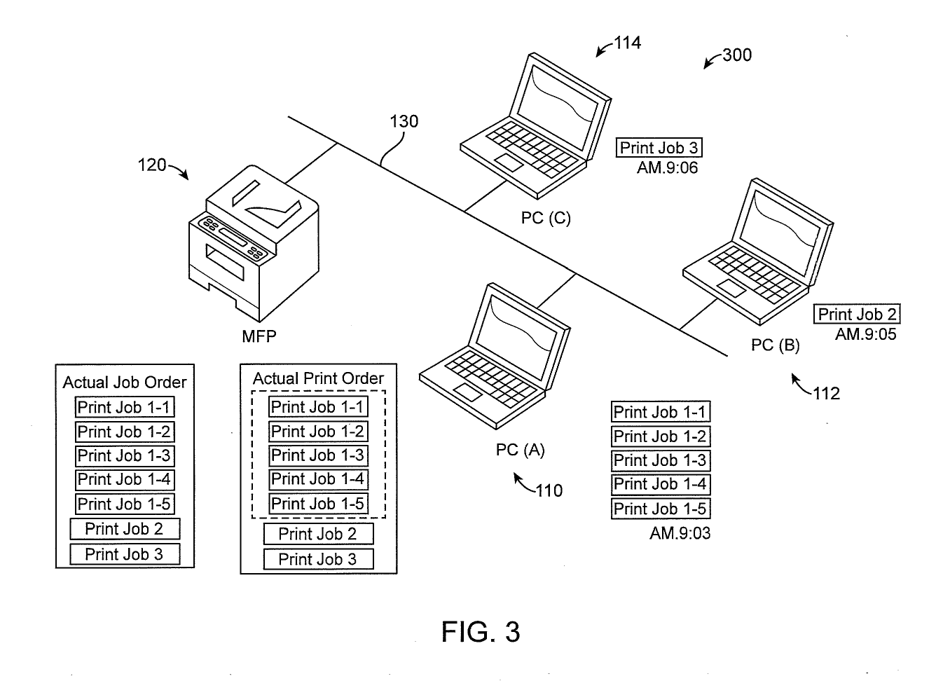

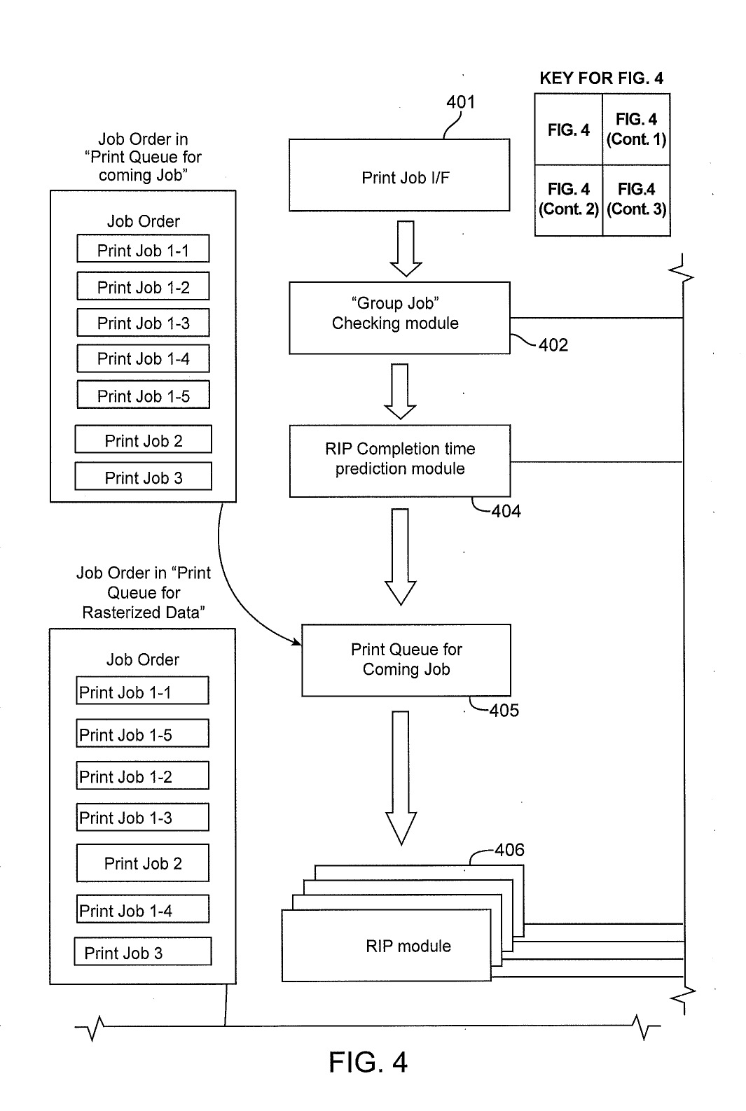

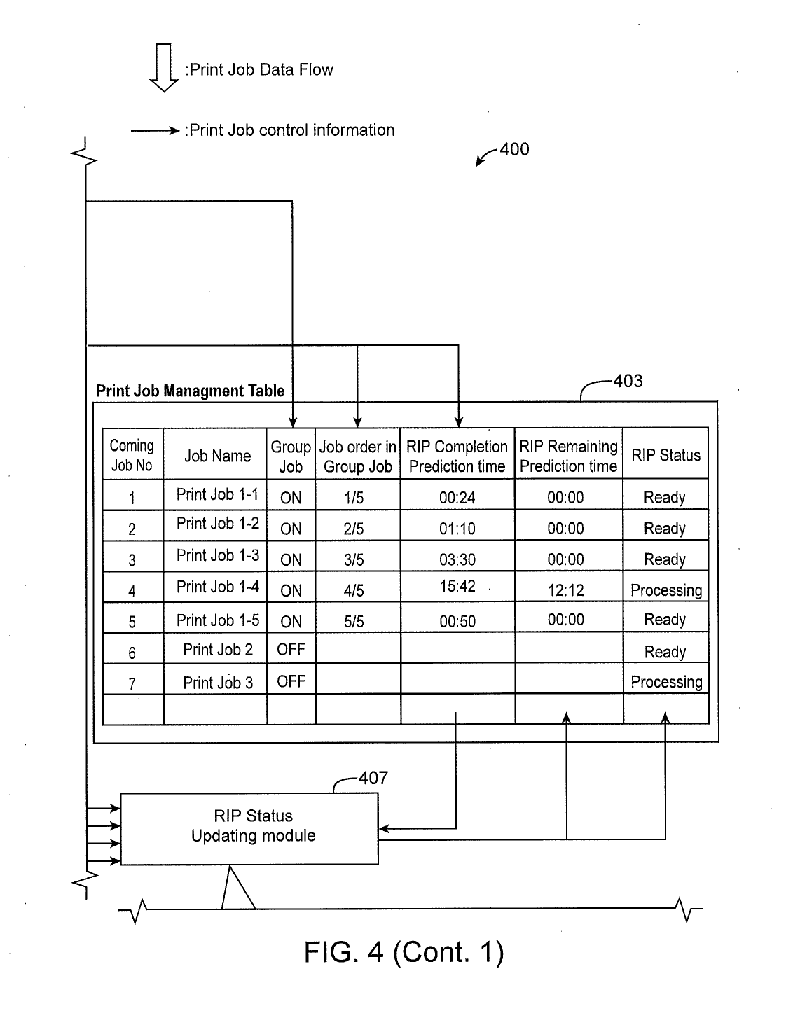

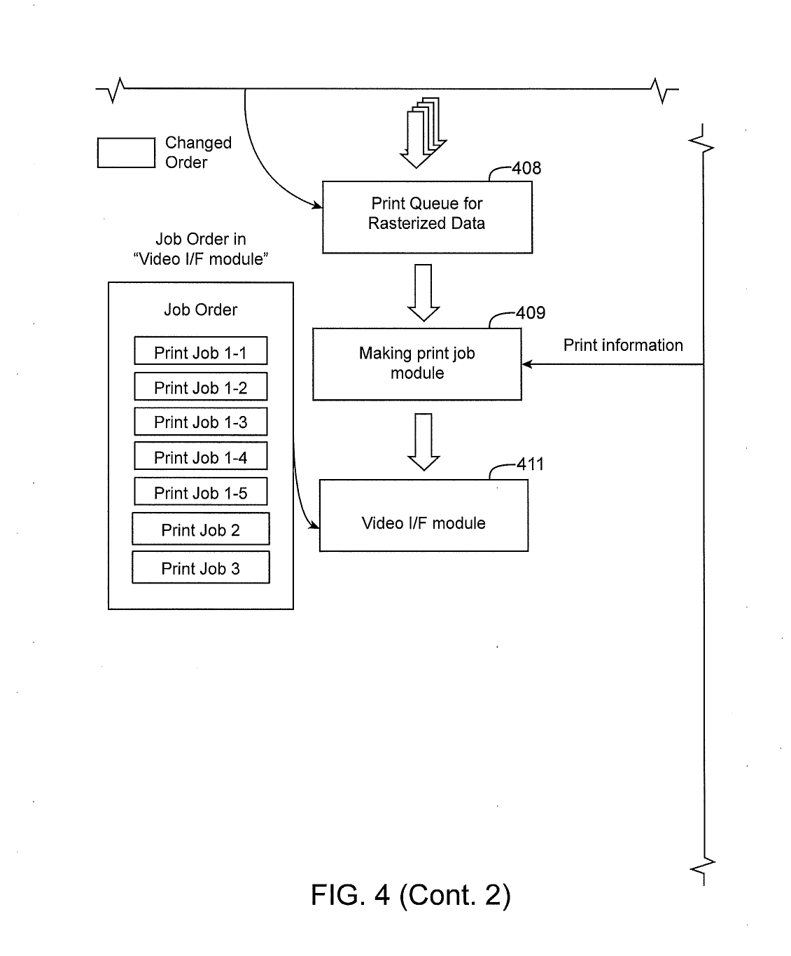

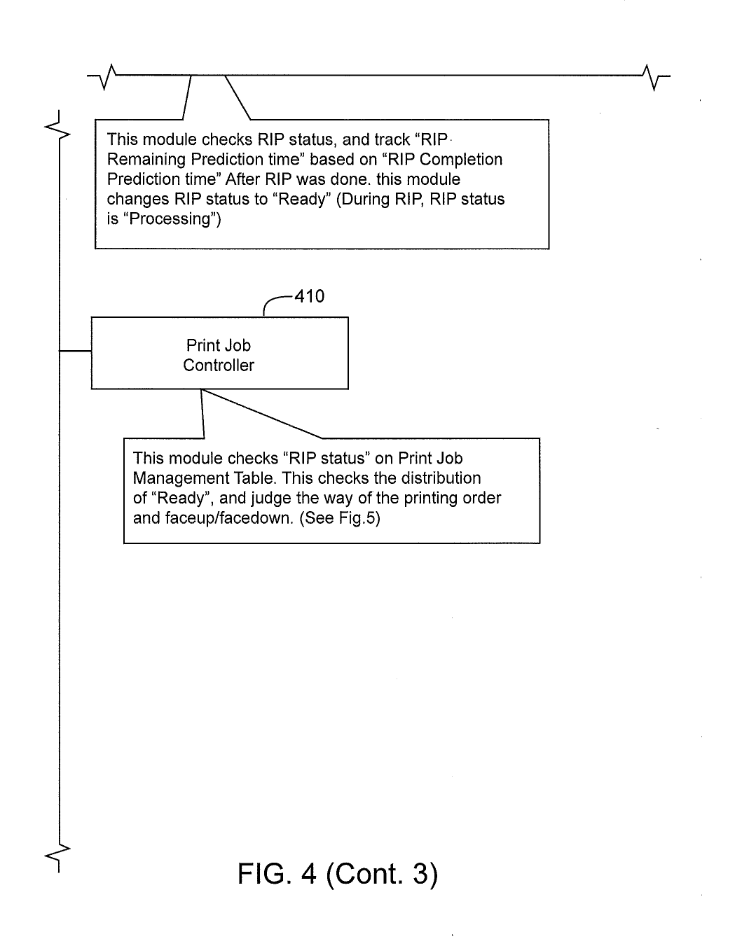

FIG. 3 is an illustration of a data processing system 300, which includes a plurality of client devices and an image forming apparatus in accordance with an exemplary embodiment. The data processing system consists of a plurality or multiple client devices 110, 112, 114 that send a sequence of print jobs to a printing device 120. Each of the plurality of client devices 110, 112, 114 and the printing device 120 is preferably connected to one another via a network connection 130. The process as shown in FIG. 3 is similar to FIG. 2, except the print job sent by client device 110 has been divided into multiple sub jobs by the printer driver of the client device 110. Alternatively, it can be appreciated that in accordance with another embodiment, that upon receipt of a large print job, the firmware and/or printer controller of the image forming apparatus generates the multiple sub-print jobs. In accordance with an exemplary embodiment, a print job management module 400 (FIG. 4), which is preferably part of the firmware of the printing device (or image forming apparatus) manages the whole of the print job as a group so that the sub-jobs can be printed in the correct sequence. It can be appreciated that the print job management module 400 can also be a separate application from the firmware of the image forming apparatus or printing device 120.

FIG. 4 is an illustration of a print job management module 400 in accordance with an exemplary embodiment. In accordance with an exemplary embodiment, the print job management module 400 is part of the firmware of the image forming apparatus or printing device 120 and includes a group checking module 402, a processing (or RIP) completion time module 404, a processing module (or RIP module) 406, a processing (or RIP) status updating module 407, a print queue for rasterized data 408, a making print job module 409, a print job controller 410, and a video I/F (interface) module 411.

As shown in FIG. 4, as incoming print jobs are received by the image forming apparatus 120, the group job checking module 402 determines the type of the print job. If the print job is determined to have a group print job attribute with a parameter value “ON” or enabled, the group job checking module 402 determines that the print job is part of a print job and is said to be a sub job (or sub-print job). The sub-job or sub-print job is assigned to the print job management table, which collects and monitors each of the sub-jobs within the print job.

In accordance with an exemplary embodiment, each and every print job will go through the completion time prediction module (or RIP completion time prediction module) 404, which provides a best estimate as to the time it may take to complete the RIP process. The processing module (or RIP module) 406 processes (i.e., RIPped) each of the sub jobs in the same manner as any other print jobs. During the RIP process, the status updating module (or RIP status updating module) 407 tracks the RIP remaining prediction time and provides updated information for the processing status (i.e., RIP status).

In accordance with an exemplary embodiment, each of the processed jobs (i.e., RIPped jobs) can be temporarily stored in a print queue for rasterized data 408. A checking mechanism in the form of a print job controller 410 tracks each of the sub-print jobs that are part of a group to determine when a print job can start printing sequentially in a top-to-bottom or bottom-to-top approach.

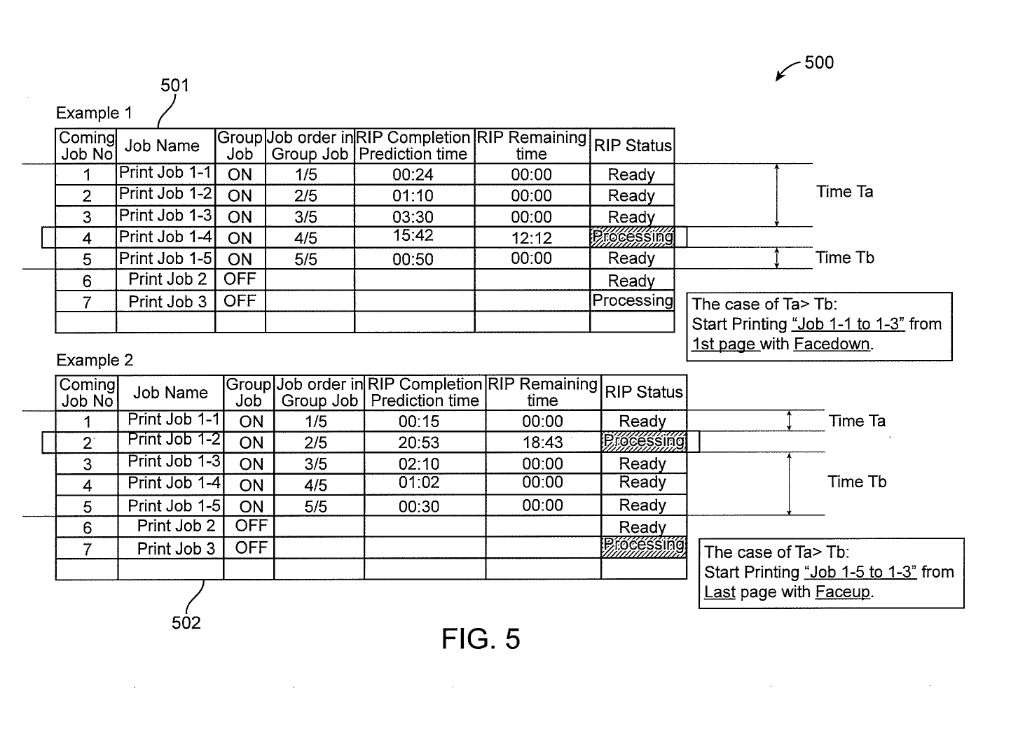

FIG. 5 is an illustration of a checking mechanism of the print job controller module 410 as shown in FIG. 4. As shown in FIG. 5, the print job controller module 410 tracks print job numbers, Job Name, group job (i.e., enabled or “ON”, and non-enabled or “OFF”), RIP completion prediction time, RIP remaining time, and RIP status. It can be appreciated that when the RIP remaining time is positive, i.e., processing of the print job is currently taking place, the RIP status as shown reads “Processing”, and when the processing is completed (i.e., RIP remaining time is equal to zero), the RIP status turns to “Ready”. In accordance with an exemplary embodiment, to determine when a print job can start the printing process, the print job controller module 410 checks for the changes in the RIP status and tracks the distribution of the “Ready” state corresponding to the position of the “Processing” state to determine the best printing performance for the printing device or image forming apparatus 120.

For example, in accordance with an exemplary embodiment, the print time of the ready jobs in the top of the print order and the ready jobs in the bottom of the print job are compared to one another. As shown in FIG. 5, “Ta” is the total time it will take to complete the printing of the “Ready” jobs in the top of the print order and “Tb” is the total time it will take to complete the printing of the “Ready” jobs in the bottom of the print order. In accordance with an exemplary embodiment, the print job controller module 410 checks the print jobs in a “Processing” state and determines the RIP remaining time. The “Processing” job RIP remaining time is then compared to time Ta and Tb. In Example 1, if “Processing” job RIP remaining time is approximately equal (or nearly approaching) to time Ta, then the printing begins on a top-to-bottom approach. Otherwise, as shown in Example 2, if the “Processing” job RIP remaining time is approximately equal (or nearly approaching) to time Tb, the print job will begin printing from a bottom-to-top approach.

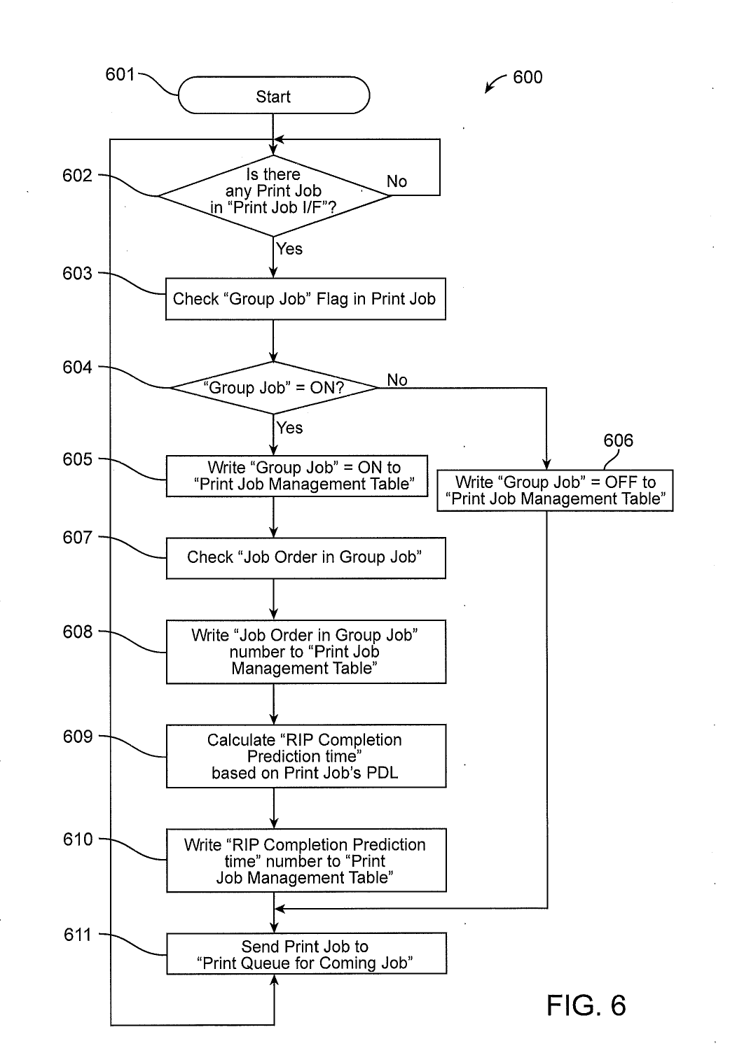

FIG. 6 is an illustration of a flowchart, which describes the process 600 in the group job checking module 402 and the RIP completion time prediction module 404. As shown in FIG. 6, the process begins in step 601, wherein the group job checking module 402 is activated. In step 602, the group job checking module 402 checks to determine if any print jobs are in the “print job I/F” (i.e., “print job interface”). If the print job I/F does not contain any print jobs, the process stops and the process is repeated until a print job is received. In step 603, once the print job I/F includes at least one print job, the group job checking module 402 checks the print job for a “group job” flag and/or other indication that the print job includes sub-jobs (or sub-print jobs). In step 604, if the print job does not include a “group job”, in step 606, the group job checking module writes the “group job” designation for the print job as “off”, and the print job is sent for processing to the “print job management table” and to step 611, “Print Queue for Coming Job” 405. Alternatively, in step 605, if the print job includes a “group job” flag (i.e., write group job “ON”), in step 607, the group job checking module 402 checks the “job order in the group job”. In step 608, the job order in group job is then written to the print job management table 403. In step 609, a “RIP completion prediction time” based on the print jobs PDL (page description language) is calculated. In step 610, the “RIP completion prediction time” is written to the print job management table 403. In step 611, the print job is sent to the “Print Queue for Coming Job” 405.

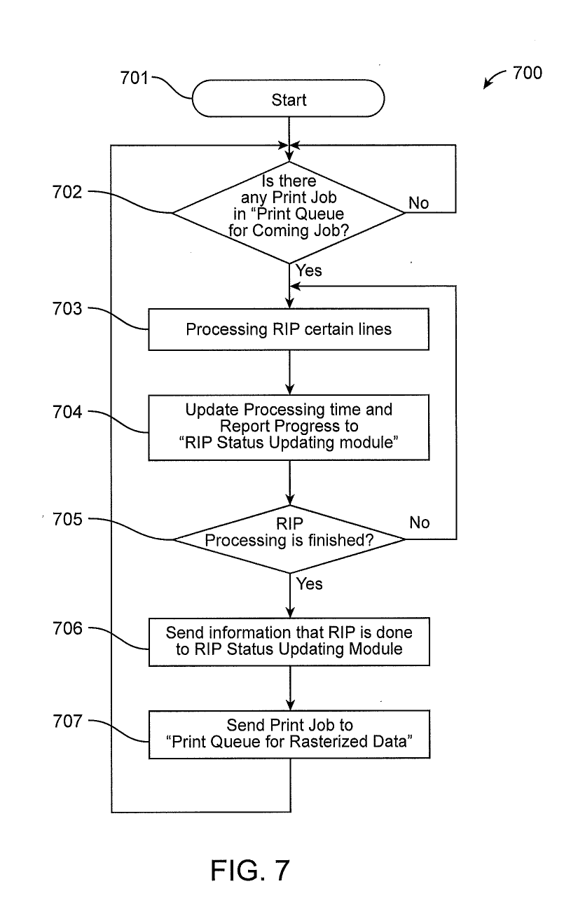

FIG. 7 is an illustration of a flowchart, which described the process 700 in the RIP module 406 in accordance with an exemplary embodiment. As shown in FIG. 7, in step 701, the RIP module is activated. In step 702, the RIP module determines if there is any print jobs in the “Print Queue for Coming Job” 405. If a print job is in the “Print Queue for Coming Job” 405, in step 703, processing RIP certain lines is performed. In step 704, an update processing time and report progress to “RIP status updating module” 407 is sent. In step 705, the RIP module 406 determines if the RIP processing is finished. If the RIP processing is not finished, the process returns to step 703. Alternatively, if the RIP processing is finished, in step 706, print information is sent to RIP status updating module 407 indicating that RIP (i.e., processing) is completed (i.e., done). In step 707, the print job is sent to “Print Queue for Rasterized Data” 408.

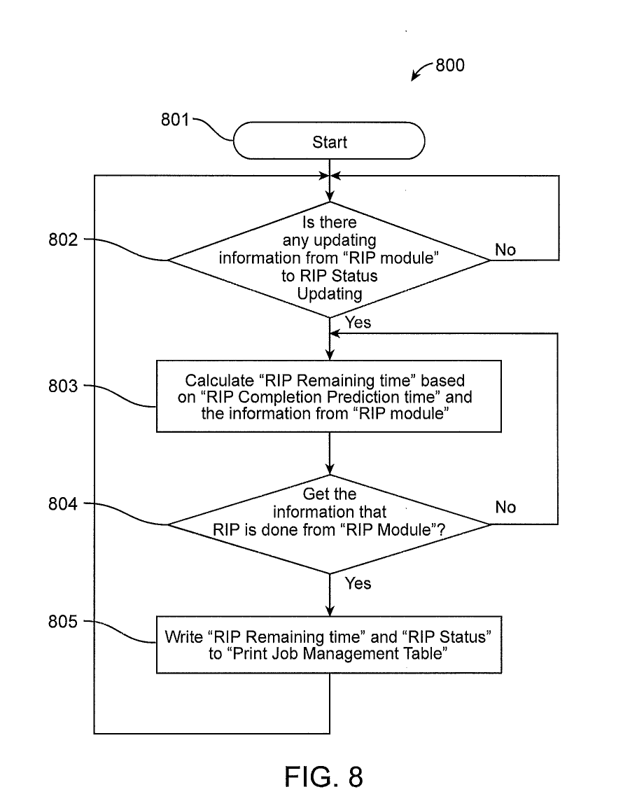

FIG. 8 is an illustration of a flowchart, which describes the process 800 in the RIP status updating module 407. In step 801, the process of the RIP status updating module 407 is activated. In step 802, the RIP status updating module 407 determines if there is any updating information from “RIP module” 406 to “RIP status updating” 407. If not, the process returns to step 802. If the answer is yes (i.e., updating information is available), in step 803, the “RIP remaining time” based on “RIP completion prediction time” and the information from the RIP module is calculated. In step 804, the RIP status updating module 407, obtains information on whether the RIP (i.e., processing) is completed from the “RIP module” 406. If the process is not completed, the process returns to step 803, and if the process is completed, in step 805, the RIP remaining time and RIP status is written to the print job management table 403.

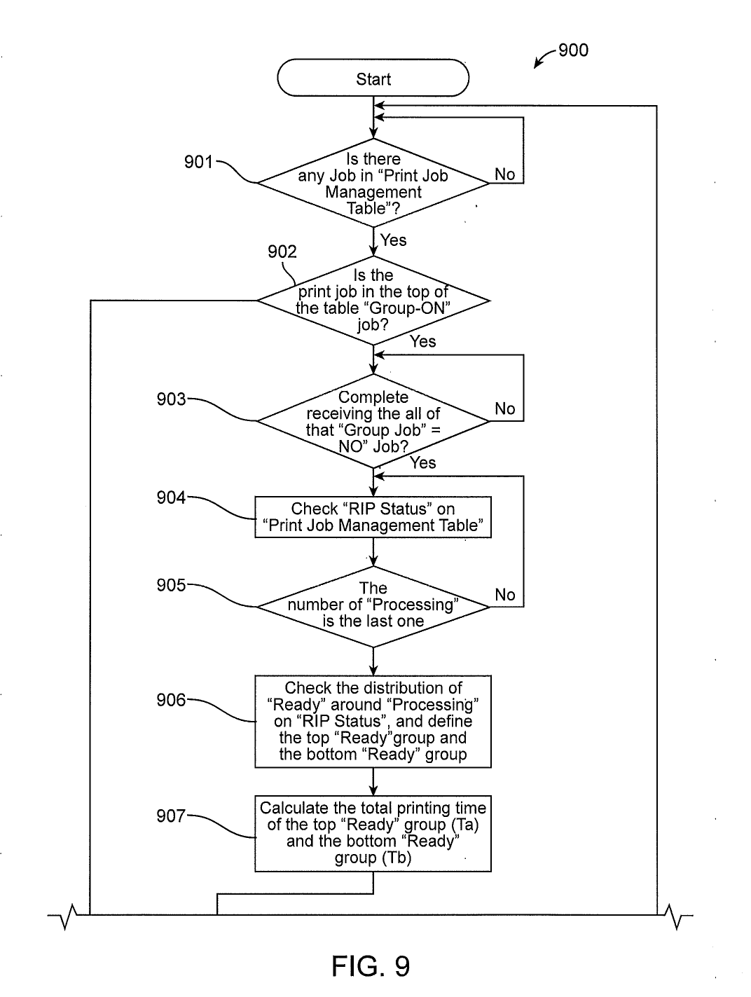

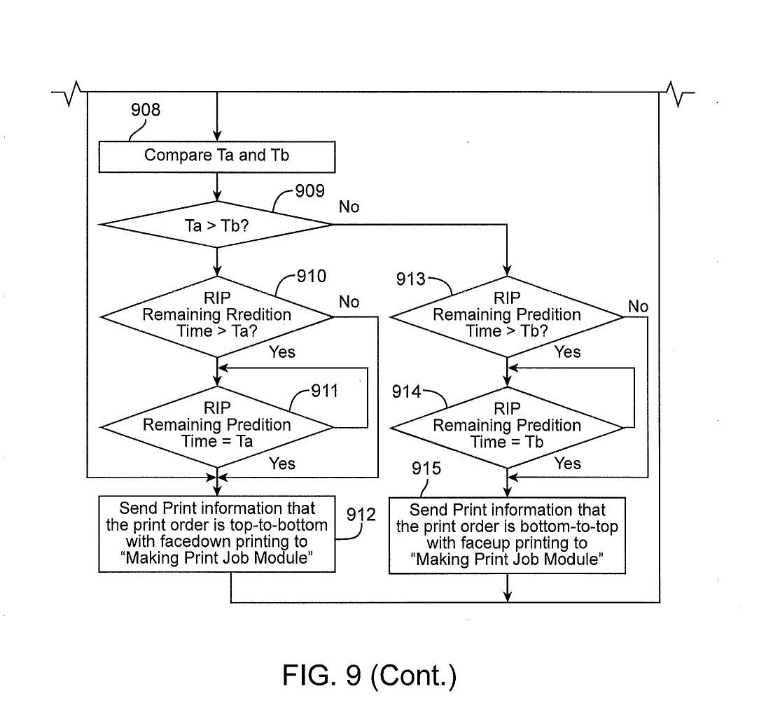

FIG. 9 is an illustration of a flowchart, which describes the processing 900 of the sub-print jobs within the print job controller 410. As shown in FIG. 9, in step 901, the print job controller 410 inquires if there is any print jobs in the print job management table 403. If there is no print jobs in the print job management table 403, the process stops. If the print job management table 403 includes at least one print job, in step 902, the print job controller 410 determines if the print job is in the top of the table of “Group-On Jobs”. If the answer is no, the print job is sent to step 912, wherein print information that the print order is top-to-bottom with facedown printing is sent to “making print job module” 409. Alternatively, if the answer in step 902 is yes, in step 903, the print job controller 410 determines if the all of the “Group Job” equal “ON” job has been completed. If the answer is no, the print job returns to step 902. Alternatively, if the answer is yes, in step 904, the print job controller 410 checks the “RIP Status” on the print job management table 403. In step 905, the number of “Processing” is the last one. If no, the process returns to step 904. If yes, the process proceeds to step 906, check the distribution of “Ready” around “Processing” on “RIP Status”, and define the top “Ready” group (i.e., top ready group) and the bottom “Ready” group (i.e., bottom ready group). In step 907, the total printing time of the top ready group (Ta) and the bottom ready group (Tb) are calculated. In step 908, the printing time of the top “Ready” group (Ta) is compared to the printing time of the bottom “Ready” group (Tb). In stop 909, if the printing time of the top ready group (Ta) is greater than printing time of the bottom ready group (Tb), then the process proceeds to step 910, wherein RIP remaining prediction time (i.e., processing time for the remaining sub-print job) is compared to Ta. If the RIP remaining prediction time is less than Ta, the process proceeds to step 912. In step 912, the print information is sent to making print job module 409, with instructions that the print job is top-to-bottom (i.e., first sheet to last sheet) with facedown printing. Alternatively, if the RIP remaining prediction time is greater than Ta, the process proceeds to step 911, wherein the printer job controller 410 continues to recalculate the RIP remaining prediction time versus Ta until the RIP remaining prediction time is equal to Ta, at which time the process proceeds to step 912, wherein the print job is printed top-to-bottom facedown.

Alternatively, if Ta is less than Tb, the process proceeds to step 913, wherein RIP remaining prediction time is compared to Tb. If RIP remaining prediction time is less than Tb, the process proceeds to step 915, which sends print information to the making print job module 409 that the print order is bottom-to-top with face-up printing. If the RIP remaining prediction time is greater than Tb, in step 914, the printer controller continues to recalculate the RIP remaining prediction time versus Tb until the RIP remaining prediction time is equal to Tb, at which time the process proceeds to step 915, wherein the print information is sent to the making print job module 409 that the print job order is bottom-to-top (i.e., last sheet to first sheet) with face-up printing.

It can be appreciated that the printing of each of the plurality of print jobs in a print sequence is generated based on a time of receipt by the image forming apparatus 120 of each of the plurality of prints jobs. In accordance with an exemplary embodiment, each of the print jobs having one or more sub-print jobs, the printing sequence is based upon receipt by the image forming apparatus of the first sub-print job.

In accordance with another exemplary embodiment, a computer program product comprising a non-transitory computer usable medium having a computer readable code embodied therein for managing a plurality of print jobs. The computer readable program code is configured to execute a process, which includes the steps of: processing a plurality of sub-print jobs that constitute a print job for printing by the image forming apparatus; assigning the plurality of sub-print jobs to a print job management module; managing the processing of each of the sub-print jobs with the print job management module, wherein the print job management module determines based on an estimated time for processing of each of the sub-print jobs, if the print job should be printed first sheet to last sheet with each of the sheets face down or last sheet to first sheet with each of the sheets face up; sending the processed sub-print jobs to a print queue for printing in an order according to the determination result by the print job management module; and printing the plurality of sub-print jobs in the print queue.

The computer usable medium, of course, may be a magnetic recording medium, a magneto-optic recording medium, or any other recording medium which will be developed in future, all of which can be considered applicable to the present invention in all the same way. Duplicates of such medium including primary and secondary duplicate products and others are considered equivalent to the above medium without doubt. Furthermore, even if an embodiment of the present invention is a combination of software and hardware, it does not deviate from the concept of the invention at all. The present invention may be implemented such that its software part has been written onto a recording medium in advance and will be read as required in operation.

It will be apparent to those skilled in the art that various modifications and variation can be made to the structure of the present invention without departing from the scope or spirit of the invention. For instance, the above mentioned embodiment is discussed in the condition where the multiple sub-print jobs are preliminary prepared in the client device 110, and they are sent to image forming apparatus 120. However, the present invention is not limited to this specific implementation; the present invention is applicable to the case where a single print job is forwarded from the client device 110 to the image forming apparatus 120, and then the image forming apparatus 120 separates or divides the single print job into multiple sub-print jobs before processing these sub-print jobs. In this alternative implementation, the image forming apparatus 120 can have the control of such separation of the single print job, and therefore, it is beneficial for the image forming apparatus 120 to decide how many sub-print jobs should be made in accordance with the resource conditions of the image forming apparatus 120. In view of the foregoing, it is intended that the present invention cover modifications and variations of this invention provided they fall within the scope of the following claims and their equivalents.

What is claimed is:

1. A method of managing a plurality of print jobs executed by an image forming apparatus, the method comprising:
processing a plurality of sub-print jobs that constitute a print job for printing by the image forming apparatus;
assigning the plurality of sub-print jobs to a print job management module;
managing the processing of each of the sub-print jobs with the print job management module, wherein the print job management module determines based on an estimated time for processing of each of the sub-print jobs, if the print job should be printed first sheet to last sheet with each of the sheets face down or last sheet to first sheet with each of the sheets face up;
sending the processed sub-print jobs to a print queue for printing in an order according to the determination result by the print job management module; and
printing the plurality of sub-print jobs in the print queue.

2. The method of claim 1, wherein the print job management module further performs the following steps:
calculating an estimated time for processing of each of the sub-print jobs; and
determining based on the estimated time for processing of each of the sub-print jobs, if the print job should be printed first sheet to last sheet with each of the sheets face down or last sheet to first sheet with each of the sheets face up.

3. The method of claim 1, wherein the print job management module during processing of the sub-print jobs performs the following steps:
dividing the plurality of sub-print jobs into a top ready group and a bottom ready group;
calculating a total printing time of the top ready group and the bottom ready group; and
comparing the printing time of the top ready group to the bottom ready group, and wherein if the total printing time of the top ready group is greater than the total printing time of the bottom ready group, printing the print job from first sheet to last sheet with each of the sheets face down, and if the total printing time of the bottom ready group is greater than the total printing time of the top ready group, printing the print job from last sheet to first sheet with each of the sheets face up.

4. The method of claim 3, further comprising:
calculating an estimated remaining processing time for remaining sub-print groups; and
printing the top ready group or the bottom ready group only after the estimated remaining processing time for the remaining sub-print groups is equal to or less than the estimated printing time for the top ready group or the bottom ready group.

5. The method of claim 3, wherein the step of calculating the total printing time of the top group to the bottom group is based on a print job's Page Description Language (PDL).

6. The method of claim 3, wherein the total printing print time comprises calculating a remaining processing time for the top group and the bottom group based on a processing completion prediction time plus the estimated printing time.

7. The method of claim 1, further comprising printing each of the plurality of print jobs in a print sequence generated based on a time of receipt by the image forming apparatus of each of the plurality of prints jobs.

8. The method of claim 7, wherein each of the print jobs having one or more sub-print jobs, the printing sequence is based upon receipt by the image forming apparatus of the first sub-print job.

9. The method of claim 1, further comprising generating the plurality of sub-print jobs on a printer driver of a client device.

10. The method of claim 1, further comprising generating the plurality of sub-print jobs on the printer controller, which is contained within the image forming apparatus.

11. An image forming apparatus having executable instructions for managing a plurality of print jobs, the instructions comprising:
processing a plurality of sub-print jobs that constitute a print job for printing by the image forming apparatus;
assigning the plurality of sub-print jobs to a print job management module;
managing the processing of each of the sub-print jobs with the print job management module, wherein the print job management module determines based on an estimated time for processing of each of the sub-print jobs, if the print job should be printed first sheet to last sheet with each of the sheets face down or last sheet to first sheet with each of the sheets face up;
sending the processed sub-print jobs to a print queue for printing in an order according to the determination result by the print job management module; and
printing the plurality of sub-print jobs in the print queue.

12. The apparatus of claim 11, wherein the print job management module further performs the following steps:
calculating an estimated time for processing of each of the sub-print jobs; and
determining based on the estimated time for processing of each of the sub-print jobs, if the print job should be printed first sheet to last sheet with each of the sheets face down or last sheet to first sheet with each of the sheets face up.

13. The apparatus of claim 11, wherein the print job management module during processing of the sub-print jobs performs the following steps:
dividing the plurality of sub-print jobs into a top ready group and a bottom ready group;
calculating a total printing time of the top ready group and the bottom ready group; and
comparing the printing time of the top ready group to the bottom ready group, and wherein if the total printing time of the top ready group is greater than the total printing time of the bottom ready group, printing the print job from first sheet to last sheet with each of the sheets face down, and if the total printing time of the bottom ready group is greater than the total printing time of the top ready group, printing the print job from last sheet to first sheet with each of the sheets face up.

14. The apparatus of claim 13, further comprising:
calculating an estimated remaining processing time for remaining sub-print groups; and
printing the top ready group or the bottom ready group only after the estimated remaining processing time for the remaining sub-print groups is equal to or less than the estimated printing time for the top ready group or the bottom ready group.

15. A computer program product comprising a non-transitory computer usable medium having a computer readable code embodied therein for managing a plurality of print jobs on an image forming apparatus, the computer readable program code configured to execute a process, the process comprising the steps of:
processing a plurality of sub-print jobs that constitute a print job for printing by the image forming apparatus;
assigning the plurality of sub-print jobs to a print job management module;
managing the processing of each of the sub-print jobs with the print job management module, wherein the print job management module determines based on an estimated time for processing of each of the sub-print jobs, if the print job should be printed first sheet to last sheet with each of the sheets face down or last sheet to first sheet with each of the sheets face up;
sending the processed sub-print jobs to a print queue for printing in an order according to the determination result by the print job management module; and
printing the plurality of sub-print jobs in the print queue.

16. The computer program of claim 15, wherein the print job management module further performs the following steps:
calculating an estimated time for processing of each of the sub-print jobs; and
determining based on the estimated time for processing of each of the sub-print jobs, if the print job should be printed first sheet to last sheet with each of the sheets face down or last sheet to first sheet with each of the sheets face up.

17. The computer program of claim 15, wherein the print job management module during processing of the sub-print jobs performs the following steps:
dividing the plurality of sub-print jobs into a top ready group and a bottom ready group;
calculating a total printing time of the top ready group and the bottom ready group; and
comparing the printing time of the top ready group to the bottom ready group, and wherein if the total printing time of the top ready group is greater than the total printing time of the bottom ready group, printing the print job from first sheet to last sheet with each of the sheets face down, and if the total printing time of the bottom ready group is greater than the total printing time of the top ready group, printing the print job from last sheet to first sheet with each of the sheets face up.

18. The computer program of claim 17, further comprising:
calculating an estimated remaining processing time for remaining sub-print groups; and
printing the top ready group or the bottom ready group only after the estimated remaining processing time for the remaining sub-print groups is equal to or less than the estimated printing time for the top ready group or the bottom ready group.

19. The computer program of claim 17, wherein the step of calculating the total printing time of the top group to the bottom group is based on a print job's Page Description Language (PDL).

20. The computer program of claim 17, wherein the total printing print time comprises calculating a remaining processing time for the top group and the bottom group based on a processing completion prediction time plus the estimated printing time.
